(19) United States
(12) Patent Application Publication
(10) Pub. No.: US 2009/0032063 A1
(43) Pub. Date: Feb. 5, 2009

(54) Solid cleaning composition and method of use

(76) Inventors: Geoffrey R. Haas, Spartanburg, SC (US); Emily W. Michaels, Taylors, SC (US); Carolina Mateus, Spartanbury, SC (US); Robert L. Schuette, Duncan, SC (US); Walter P. Horton, Rutherfordton, NC (US)

Correspondence Address: Legal Department (M-495), P.O. Box 1926, Spartanburg, SC, 29304, US

(21) Appl. No.: 11/881,916

(22) Filed: Jul. 30, 2007

(51) Int. Cl. B08B 7/04; C11D 17/00

(52) U.S. Cl. 134/18; 510/445; 510/446

(57) ABSTRACT

This invention relates to solid cleaning compositions and the method for using the solid compositions to clean appliances and other soiled surfaces. The solid cleaning composition is generally comprised of a majority by weight of a cleaning active system; ingredients for forming the cleaning active system into a solid form; and optionally, a fragrance. The solid cleaning composition is ideally suited for reducing and/or eliminating microbial growth, including biofilm growth, contained within and/or on appliances, particularly those appliances that have water contact surfaces such as washing machines and dishwashers. The solid cleaning composition further provides reduction and/or elimination of undesirable odor and staining typically associated with such microbial growth.

### FIELD OF THE INVENTION

This invention relates to solid cleaning compositions and the method for using the solid compositions to clean appliances and other soiled surfaces. The solid cleaning composition is generally comprised of a majority by weight of a cleaning active system; ingredients for forming the cleaning active system into a solid form; and optionally, a fragrance. The cleaning active system is generally comprised of a solid oxidizing agent and one or more compounds selected from the group consisting of a metal chelating agent and a carbonate-based compound. The solid oxidizing agent may be selected from percarbonate-based compounds. The ingredients for forming the cleaning active system into a solid form are selected from the group consisting of an acid component, a polyalkylene glycol compound, and mixtures thereof. The solid cleaning composition is ideally suited for reducing and/or eliminating microbial growth, including biofilm growth, contained within and/or on appliances, particularly those appliances that have water contact surfaces such as washing machines and dishwashers. The solid cleaning composition further provides reduction and/or elimination of undesirable odor and staining typically associated with such microbial growth.

### BACKGROUND OF THE INVENTION

Many different types of cleaning compositions have been developed for use in preventing and controlling the growth of microbes. These include, for example, bleach compositions and detergent formulations that include bleach compositions. However, with the continual introduction of new consumer products, there exists a constant demand in the marketplace for protection against bacterial and fungal growth presented by some of these new products. Of particular concern, the present invention is directed toward reducing and/or eliminating the growth of microbes and biofilm in home appliances and/or equipment that have water contact surfaces. Examples of home appliances having water contact surfaces include washing machines, dishwashing machines, and the like. Other equipment having water contact surfaces include whirlpool-type bathtubs, in-home humidifiers and de-humidifiers, air conditioning units, dishwashers, and the like.

Using the example of washing machines, the growth and proliferation of microbes in a washing machine generally occurs from prolonged exposure to warm, moist environments which may contain soap residue and clothing residue, such as body oils, fiber particles, and dirt and bacteria from the clothing. This environment leads to the development of undesirable odors and biofilm. Biofilm is the growth of microbes, such as bacteria and fungi, on a surface. Biofilms are commonly surrounded by an exopolymeric matrix. Both the abundant microbial growth and matrix production result in visible microbial communities, thus damaging the aesthetic appeal of the surface. Additionally, secondary metabolites produced as a result of microbial growth include volatile organic compounds (VOCs) that can be detected by the consumer as foul odors.

Front loading laundry machines, in particular, provide an ideal environment for microbial growth in any of the water-contact locations in the machine. The four major components of the machine are generally the polypropylene wash tub, stainless steel wash cylinder, aluminum support bracket and the circular door sealing gasket (also known as a “bellow”) which provides a seal between the wash compartment and the door of the washing machine. Biofilms may form on the washing machine bellow, on the piping and tubing which connects the parts and carries the water to and from the machine, on the inner surface of the outer wash tub and on the outer surface of the inner wash tub. As the microbes in the biofilm grow, they tend to penetrate the supporting surface resulting in staining of the surface to which the microbes attach. Microbial growth further leads to degradation of the machine parts which potentially results in reduced life cycle of the parts or the entire laundry machine. Additionally, in the process of biofilm growth and maturation, portions of the biofilm may detach and come into contact with clothing, towels, sheets, etc. that are laundered in the washing machine. This biofilm-to-clothing contact may undesirably and irreversibly stain and leave a residual odor on the clothing that comes into contact with the detached biofilm during the laundering process.

Both top loading and front loading washing machines experience foul odors (both in the machine and transferred to the clothes) as well as mold and staining issues. These problems are thought to originate from biofilm formation on components comprising the washers. The staining on the rubber door bellow is often visible to the consumer after several months. Foul odors caused by the biofilm in other areas of the machine are often noticeable within three months of field use. In worst case scenarios, the odor from the machine is transferred to the clothing.

This problem of microbial growth and proliferation in appliances and equipment having water contact surfaces, particularly in washing machines, has been manifested, in part, by the desire to manufacture more energy efficient and environmentally friendly consumer products. For instance, the laundry care industry is producing high efficiency washing machines designed to clean clothing at lower wash water temperatures. Regulations restricting water volumes in such appliances and the use of excessive liquid laundry detergents have been mandated in some countries. Thus, increased production of front loading washing machines and machines designed to clean clothing at lower temperatures and lower water volumes has created a need for cleaning compositions capable of reducing and/or eliminating microbial growth on water contact surfaces contained within these machines.

One remedy to this problem that is provided by washing machine manufacturers is to include a cleaning cycle as part of the standard offering on the machine cycle dial. Thus, the user care guide and machine cycle dial recommends to machine owners that they should run a periodic cleaning cycle on the machine using a large amount of bleach. In some washing machine models, such as the high efficiency front loading machine, an indicator maintenance light is built into the machine. The light is designed to turn on at regular time intervals (e.g. every 30 days, every six months, etc.) as a reminder to the consumer that it is time to run a cleaning cycle in the machine.

For instance, US Patent Publication Nos. 2005/0262883 to Yang et al., 2005/0265890 to Yang et al., and 2005/0262645 to Yang et al. disclose a washing machine having a deodorizing unit contained therein for removing odors from objects placed in the wash tub. An electronic nose sensor generates a response based on the type and kind of odor particles or gas present in the tub. Odors are removed by spraying water onto the objects in the tub and blowing hot air, thereby moving the offensive odor particles to an air outlet present on one side of the tub. This deodorizing cycle is operated separately from the wash cycle. In addition to the deodorizing unit, the washing machine may also possess an ozone-generating unit and/or an ultraviolet lamp for deodorizing objects.

Additionally, U.S. Pat. No. 6,463,766 to Kubota et al. discloses a washing machine with means for preventing propagation of microorganisms. The washing machine is manufactured with a deposition section in the water supply hose from the water source to the wash tub (i.e., a split water line) which also includes a solid antimicrobial agent disposed therein. The solid antimicrobial agent is contained in a cassette case. Upon contact with water, the solid antimicrobial agent, e.g. an organic compound having nitrogen and halogen atoms, releases the antimicrobial agent, e.g. hypohalogenous acid, into the water of the washing machine. The antimicrobial mode is provided as a cycle on the washing machine which the consumer can choose to activate. This product requires a filter for catching any pieces of the antimicrobial agent that breaks off from the solid shape and may enter the washing machine. If the pieces were to enter the washing machine, the antimicrobial agent may discolor the laundry items contained in the wash tub. The cycle time for running the antimicrobial agent into the machine is also longer than the normal wash cycle.

Other attempts to control this problem are addressed by US Patent Publication No. 2003/0008085 to Davenet et al. which discloses a laundry bag for holding soiled laundry in a washing machine. The laundry bag may include a dispensing unit which allows for the delayed release of a bleaching agent into the washing machine.

Thus, since washing machines are currently being designed to have a cleaning cycle built in for use by the consumer in preventing/removing microbial growth, the need exists for chemical compositions which may be added to the machine for use during this cleaning cycle. Attempts by others to create cleaning compositions for use in appliances and equipment as described herein have included bleach or bleach-containing compositions and other peroxide-based compositions which, as will be shown by example herein, fail to adequately clean and remove microbes, biofilm and any other buildup from the interior of machines having water contact surfaces. Furthermore, the use of bleach or bleach-containing products (e.g. chlorine bleach products) often leads to corrosion problems on various parts within the machine.

U.S. Pat. No. 5,620,527 to Kramer et al. discloses a cleansing and disinfecting composition using an alkaline per-salt and a positively charge phase transfer agent. The composition also contains a surfactant. U.S. Pat. No. 5,320,805 to Kramer et al. discloses a composition including from about 10% to about 90% weight of an alkaline water-soluble salt having hydrogen peroxide of crystallization and from about a fraction of a percent to about 30% by weight of a positively charged phase-transfer agent. These compositions are useful as disinfectants in the health care industry by application directly to the skin or by incorporation into wipes, sponges, and brushes.

U.S. Pat. No. 7,018,642 to Degenhardt et al. teaches compounds, compositions and methods for controlling biofilms in high humidity home appliances. The composition is comprised nitrogen heterocyclic compounds chemistries to control biofilms.

U.S. Pat. No. 7,041,633 to Tcheou discloses a process for preparing a detergent tablet, comprising the step of contacting a liquid binder to a base powder. The liquid binder includes a nonionic surfactant and a dissolution aid. The tablet is coated with a combination of dicarboxylic acid and an anion exchange resin or a clay. The liquid binder may include twenty percent or less of polyethylene glycol; however, it is most preferred that the liquid binder if free of polyethylene glycol. The dissolution aid preferably comprises an organic sulfonated compound such as salts of aryl sulfonic acids. The base powder is typically a pre-formed detergent granule.

U.S. Pat. No. 6,254,892 to Duccini et al. discloses chemical compositions in the form of pellets which disintegrate quickly and efficiently in aqueous media and a method of producing the pellets. The pellets are comprised of three parts: a chemical active portion (such as laundry detergent), a disintegration component (such as cross-linked polyacrylate water absorbent polymers), and a water transport agent (such as amorphous cellulose or synthetic hollow fibers).

U.S. Pat. No. 6,670,320 to Cao et al. teaches a unit dose wash cycle fabric softening composition for softening and conditioning fabrics in the wash cycle of an automatic washing machine. The fabric softener is in an amount sufficient to form a unit dose capable of providing effective fabric softening. The fabric softener is comprised of montmorillonite-containing clay compound and a disintegration agent, such as swelling polymers, cellulose and electrolytes.

U.S. Pat. No. 7,041,632 to Holderbaum et al. discloses a process for the production of single-phase or multi-phase detergent shaped bodies containing surfactants, builder, perfume and other typical ingredients of detergent shaped bodies. The detergent shaped bodies are formed by subjecting a perfume-free detergent shaped body to a perfume such that the resulting product exhibits improved odor impression. The detergent shaped bodies are of the type used in laundry or dishwashing detergents.

U.S. Pat. Nos. 6,518,313; 6,028,113; and 5,977,183 to Scepanski disclose solid sanitizers and cleaner disinfectants and solid antimicrobial compositions. The compositions are comprised of solidified, non-flowable quaternary ammonium salts, alcohol alkoxylates, urea, and optionally fragrance and dyes. The compositions are initially prepared as a liquid melt which can be poured into a container where, upon cooling, the compositions solidify. The container is inverted and connected to a water supply, which dissolves the composition, and the dissolved composition may then be sprayed through a dispensing hose for use in sanitizing tables and fixtures in a food processing plant.

The present disclosure addresses and overcomes the problems described above. As one potentially preferred embodiment of the present invention, the solid cleaning composition is generally comprised of (a) a majority by weight of a cleaning active system which includes a solid oxidizing agent and one or more compounds selected from the group consisting of a metal chelating agent and a carbonate-based compound, (b) an acid component and (c) a polyalkylene glycol component. The solid cleaning composition may optionally include a fragrance. The composition is ideally suited for reducing and/or eliminating microbial growth, including biofilm growth and scum build up contained within and/or on appliances, particularly those appliances that have water contact surfaces such as washing machines and dishwashers. Unlike many of the solutions previously described, the composition of the present invention does not have a negative effect on the machine parts, clothes, tableware, septic/sewer system, etc. Additionally, the composition has been designed to work with the machine cycle conditions (time, temperature, water volume, etc.) and to reduce or eliminate both the biological and the abiotic build up. For these reasons and others that will be described herein, the present solid cleaning composition represents a useful advance over the prior art.

### BRIEF DESCRIPTION OF THE DRAWINGS

FIG. 1 is a bar graph illustrating the biofilm removal efficacy of cleaning tablets of the present invention on various substrates both with and without scale build-up.

### DETAILED DESCRIPTION OF THE INVENTION

All U.S. and foreign patents and U.S. patent applications disclosed in this specification are hereby incorporated by reference in their entirety.

### Solid Cleaning Composition

The solid cleaning composition is generally comprised of a majority by weight of a cleaning active system; ingredients for forming the cleaning active system into a solid form; and optionally, a fragrance.

### “Cleaning Active System”

The cleaning active system is generally comprised of a solid oxidizing agent and one or more compounds selected from the group consisting of a metal chelating agent and a carbonate-based compound.

The solid oxidizing agent may be selected from percarbonate-based compounds. Percarbonate-based compounds include, for example, sodium percarbonate compounds. Sodium percarbonate is also known by other names such as sodium carbonate peroxyhydrate and sodium carbonate peroxide.

One commercially available percarbonate-based product suitable for the solid cleaning composition of the present invention is FB® 400 sodium percarbonate available from Solvay Chemicals. This product is a free flowing white granular powder and has an average particle size of 400-550 microns. This product also contains an active available oxygen content equivalent to 27.5% hydrogen peroxide.

The solid oxidizing agent may be present in an amount between 1% and 95% by weight of the total composition, preferably between 10% and 95% by weight, and more preferably between 30% and 95% by weight. It may be most preferable that the solid oxidizing agent is present in an amount between 50% and 95% by weight of the total composition. Thus, the cleaning composition may be comprised of a majority by weight of a solid oxidizing agent.

The metal chelating agent may be selected from the group consisting of ethylene diamine tetracetic acid (“EDTA”), tetraacetylethylenediamine (“TAED”) and combinations thereof. The metal chelating agent may aid in the removal of deposits from the machine and/or to remove calcium from the biofilm to weaken its structure and allow for easier removal of the biofilm. The metal chelating agent may be present in an amount between 0.001% and 30% by weight of the total composition, preferably between 0.01% and 20% by weight, and more preferably between 0.1% and 10% by weight of the total composition. It may be most preferable that the metal chelating agent is present in an amount between 1% and 5% by weight of the total composition.

The carbonate-based compound may include, for example, sodium carbonate, sodium bicarbonate and mixtures thereof. It may be preferable that the carbonate-based compound has a particle size that is smaller than the percarbonate-based compound. Accordingly, the carbonate-based compound may complement the percarbonate-based compound, by occupying the small spaces between the percarbonate-based compounds. Also, the carbonate-based compound may serve as a carrier for other compounds present in the solid cleaning composition. For example, the carbonate-based compound may serve as a carrier for liquid ingredients that are added to the composition. In this capacity, the carbonate-based compound may assist in providing a solid cleaning composition in which all of the ingredients are uniformly dispersed within the composition.

The carbonate-based compound may be present in an amount between 0.001% and 90% by weight of the total composition, preferably between 1% and 60% by weight, and more preferably between 5% and 30% by weight. It may be most preferable that the carbonate-based compound is present in an amount between 10% and 25% by weight of the total composition.

In one embodiment, it may be desirable that the cleaning active system consists of a solid oxidizing agent and a metal chelating agent. More specifically, it may be desirable that the cleaning active system consists of sodium percarbonate and ethylene diamine tetracetic acid. Even more specifically, it may be desirable that the cleaning active system consists of sodium percarbonate in an amount between 50% and 95% by weight of the total weight of the solid cleaning composition and ethylene diamine tetracetic acid in an amount between 0.1% and 10% by weight of the total weight of the solid cleaning composition. Thus, the solid cleaning composition is comprised of a majority by weight of the cleaning active system.

In another embodiment, it may be desirable that the cleaning active system consists of a solid oxidizing agent, a metal chelating agent and a carbonate-based compound. More specifically, it may be desirable that the cleaning active system consists of sodium percarbonate, ethylene diamine tetracetic acid and sodium carbonate. Even more specifically, it may be desirable that the cleaning active system consists of sodium percarbonate in an amount between 50% and 70% by weight of the total weight of the solid cleaning composition, ethylene diamine tetracetic acid in an amount between 1% and 5% by weight of the total weight of the solid cleaning composition, and sodium carbonate in an amount between 10% and 25% by weight of the total weight of the solid cleaning composition. Thus, the solid cleaning composition is comprised of a majority by weight of the cleaning active system.

“Ingredients for Forming the Cleaning Active System into a Solid Form”

The ingredients for forming the cleaning active system into a solid form generally include one or more compounds selected from the group consisting of an acid component and a polyalkylene glycol component.

The acid component may be selected based on its functionality and compatibility with the other ingredients of the solid cleaning composition. Functionality may include features such as effervescence, dissolution rate, tablet hardness, mold release, and the like. It may be also be preferable to choose acid components that are readily available in powder form, since the cleaning composition is intended for use as a solid. Examples of suitable acid components include carboxylic acids such as citric acid, succinic acid, fumaric acid, stearic acid, and the like, and mixtures thereof. These carboxylic acids tend to provide an effervescent feature to the solid cleaning composition. Other acid components, such as boric acid, may aid in providing release of the solid cleaning composition from a forming mold, such as a mold used to form tablets. Additional non-limiting examples of acid components include lactic acid. Mixtures of any of the foregoing acid components may be utilized.

The acid component may be present in an amount between 0.001% and 60% by weight of the total composition, preferably between 1% and 50% by weight, and more preferably between 5% and 40% by weight of the total composition. It may be even more preferable that the acid component is between 10% and 40% by weight of the total composition, and most preferable that the acid component is present in an amount between 20% and 40% by weight of the total composition.

The polyalkylene glycol component may be selected from the group consisting of polypropylene glycol, polyethylene glycol, polybutylene glycol and combinations thereof. The polyalkylene glycol component may serve to aid in binding the components of the cleaning composition together. Without being bound by theory, the polyalkylene glycol component may also aid releasing the solid cleaning composition from a mold, such as a mold used to form tablets. It may be preferable that the polyalkylene glycol component has a molecular weight of less than or equal to 10,000. It may be more preferably that the polyalkylene glycol component has a molecular weight of less than or equal to 8000. It may be even more preferably that the polyalkylene glycol component has a molecular weight of less than or equal to 1000. It may be most preferable that the polyalkylene glycol component has a molecular weight of less than or equal to 500.

The solid cleaning composition may contain the polyalkylene glycol component within the composition, or the solid cleaning composition may be coated with the polyalkylene glycol component. Alternatively, the solid cleaning composition may contain the polyalkylene glycol component within the composition, and it may be coated with the polyalkylene glycol component. The polyalkylene glycol component may be present in an amount between 0.001% and 30% by weight of the total composition, preferably between 0.01% and 20% by weight, and more preferably between 0.1% and 10% by weight of the total composition. It may be most preferable that the polyalkylene glycol component is present between 0.5% and 5% by weight of the total composition.

### “Optional Ingredients”

One or more optional ingredients may be added to the solid cleaning composition. For example, a compound which provides a desirable odor to the solid cleaning composition, such as a fragrance or perfume, may be included in the solid cleaning composition. A fragrance, or perfume, may be any compound known to impart a desirable odor to a composition. A fragrance may be included in the composition to leave the machine with a fresh, clean scent after removal of the odor-causing microbes and biofilm. The fragrance may be comprised of naturally occurring compounds, or it may be comprised of synthetically made compounds. Fragrances may include, merely as an example, oils, such as citric oils. The fragrance may be present in an amount between 0.001% and 20% by weight of the total composition, preferably between 0.01% and 10% by weight, and more preferably between 0.1% and 5% by weight of the total composition. It may be most preferable that the acid component is between 0.1% and 3% by weight of the total composition.

Other ingredients may be added to the solid cleaning composition, depending on the specific end-use of the composition. These additives may include, for example, defoamers or antifoaming agents, surfactants, pesticides, coloring agents, antifungal agents, antimicrobial agents, effervescents, slow release agents, coating agents, soil release agents, fillers (e.g. sorbitol), and the like, and mixtures thereof. These other additives may be present in an amount between 0.001% and 25% by weight of the cleaning composition, preferably between 0.01% and 15% by weight, and more preferably between 0.1% and 5% by weight of the cleaning composition.

A defoamer or antifoaming agent may be desired to aid in the prevention or reduction of foaming during the cleaning cycle. Non-limiting examples of defoamers include silicone-containing compounds, mineral oils, fatty acids, and the like, and combinations thereof.

Surfactants may be added to help reduce the surface tension of the water in the washing machine and/or to loosen the deposits for removal. The surfactant may be selected from the group consisting of anionic surfactants, cationic surfactants, nonionic surfactants, inorganic surfactants, and combinations thereof. Nonionic surfactants, inorganic surfactants and combinations thereof may be preferred surfactants. Specific examples of these preferred surfactants include quaternary ammonium compounds, amines (such as coco alkyl dimethyl amine), alcohol ethoxylates (such as lauryl alcohol ethoxylate) and combinations thereof.

It is further contemplated that one or more additional ingredients may be added to the solid cleaning composition as a coating or film. For instance, a coating or film may be added to the solid cleaning composition including, for example, PEG coatings or films, water soluble films, water soluble coatings and the like.

### Method of Forming a Solid Cleaning Composition

The ingredients of the solid cleaning composition may be combined together into any solid form that is desired for its intended end use application. For example, the solid cleaning composition may be formed into granulated particles of generally uniform size, or it may be formed into a solid tablet. If it is desirable that the solid cleaning composition be provided in the form of granulated particles, it may be desirable that the particle shape be greater than one-quarter of an inch in size so that the granulated particles will not fall through the holes in the bottom of the wash tub. Alternatively, if the cleaning composition is formed into a solid tablet, it may be desirable that the size of the tablet is modified to fit into any dispensers or areas of the machine in which it will be placed by the consumer for use. The tablet may have a weight in the range from about 5 grams to about 200 grams, more preferably from about 20 grams to about 150 grams, and most preferably from about 40 grams to about 100 grams.

Formation of the cleaning composition into solid form may be achieved by generally standard processes known in the art for creating granulated particles or solid tablets. If the ingredients of the composition are provided in liquid form, then they should be dehydrated by any means known to those skilled in the art for removing liquid from a composition. For instance, dehydration may be accomplished by heating the composition, such as in a hot air oven, by evaporation, by exposure to an infrared source, and the like, and combinations thereof.

After dehydration of the cleaning composition, the dry residue that remains may be combined with other ingredients, such as those described previously, and formed into the desired shape for the solid cleaning composition. Such shape manipulation may be performed by any means known for forming particles and other solid shapes. For instance, the dry ingredients may be combined together in a hydraulic press to form a solid tablet. After formation of the granulated particles or solid tablet, other additives may be added to the outside of the solid cleaning composition if desired.

One potentially preferred embodiment includes the formation of a solid cleaning tablet for use in a washing machine. In front loading washing machines, it is desirable that the solid cleaning tablet have a size and shape that allows the tablet to remain in the back of the wash tub so that the tablet does not contact the baffles that protrude inward from the wash tub. Such contact with the baffles would lead to early breaking and dissolution of the tablet and thus, less than optimal cleaning of the machine. The tablet should also be large enough and have a slow enough dissolution rate that it does not dissolve significantly during the first rinse cycle of the cleaning cycle and leave the wash tub through the drain holes in the wash tub. Finally, the tablet should be of a small enough size and weight that it does not set off the weight sensors that are built into the cleaning cycle of the washing machine. The cleaning cycle is designed to sense whether there are clothes in the machine at the beginning of the cycle. If there is a tablet in the wash tub that is too large, the weight sensors will detect it and send a signal to the machine that a normal wash cycle should occur rather than the cleaning cycle. Such a situation would result in wasted cleaning products, water, and energy.

After the first rinse cycle, the second rinse cycle will begin and the tablet should be designed to dissolve completely during this second rinse cycle for optimum cleaning of the washing machine. Ideally, the solid cleaning composition should dissolve completely in either hot water or cold water and should contain ingredients which are not detrimental to the machine or the clothing that will be put into the machine after a cleaning cycle has been performed.

Thus, the solid cleaning tablet exhibits a rate of dissolution in the wash tub of a washing machine during a cleaning cycle characterized in that: (a) the tablet does not substantially dissolve during an initial rinse phase of the cleaning cycle and (b) the tablet dissolves during a subsequent phase of the cleaning cycle such that a substantial amount of the tablet does not remain in the wash tub at the end of the cleaning cycle.

While it is may be desirable that the cleaning composition of the present invention is formed into a solid tablet for ease of use, it is also contemplated to be within the scope of this invention that the cleaning composition is provided in any form that is capable of delivering the composition to the device which is to be cleaned. For instance, the solid cleaning composition may be in the form of a powder that is placed within a sachet or pouch. The solid cleaning composition may be present as a textile sheet coated with the composition. The solid cleaning composition may be present as a powder that is encapsulated within a water soluble film.

### EXAMPLES

The invention may be further understood by reference to the following examples which are not to be construed as limiting the scope of the present invention.

### A. Solid Cleaning Compositions

The following solid cleaning compositions were prepared. Many of the compositions were tested for various performance parameters such as biofilm removal and odor reduction. The values shown below for the formulations are provided as percent by weight based on the total weight of the solid cleaning composition.

The powder formulations below were made by dry blending the various ingredients in a tumble blender or by using a kitchen aid style mixer at ambient temperature. When preparing formulations containing effervescence ingredients (e.g. citric acid), the relative humidity of the mixing environment was controlled to as low a level as practically possible.

The solid tablet formulations were initially prepared in the same manner as the powder formulations. The resultant mixed powder was then placed into a machined stainless mold (i.e. a mold used to form tablets) available from Carver, Inc. of Wabash, Ind. The tablets were formed at compression pressures ranging from 500 psig to 2000 psig.

“Formula 1”
(Granular Powder)

| Ingredients | Amount (Percent by Weight) |
|---|---|
| Sodium percarbonate | 83.25 |
| EDTA | 15 |
| Syn Fac DG | 1.05 |
| (lauryl alcohol ethoxylate | |
| surfactant) | |
| Fragrance | 0.7 |

“Formula 2”
(Granular Powder)

| Ingredients | Amount (Percent by Weight) |
|---|---|
| Sodium percarbonate | 98.25 |
| Syn Fac DG | 1.05 |
| Fragrance | 0.7 |

“Formula 3”
(Granular Powder)

| Ingredients | Amount (Percent by Weight) |
|---|---|
| Sodium percarbonate | 92 |
| EDTA | 7.3 |
| Fragrance | 0.7 |

“Formula 4”
(Granular Powder)

| Ingredients | Amount (Percent by Weight) |
|---|---|
| Sodium percarbonate | 89 |
| EDTA | 7.3 |
| Syn Fac DG | 1 |
| Antifoam Y 30 (silicon- | 2 |
| based defoamer) | |
| Fragrance | 0.7 |

“Formula 5”
(Solid Tablet)

| Ingredients | Amount (Percent by Weight) |
|---|---|
| Sodium percarbonate | 71.2 |
| EDTA | 5.8 |
| Citric Acid | 20.0 |
| Antifoam Y 30 | 1.6 |
| Syn Fac DG | 0.8 |
| Fragrance | 0.6 |

“Formula 6”
(Solid Tablet)

| Ingredients | Amount (Percent by Weight) |
|---|---|
| Sodium percarbonate | 72 |
| EDTA | 5 |
| Granulated PEG 8000 | 20.0 |
| (polyethylene glycol having | |
| molecular weight of 8000) | |
| Antifoam Y 30 | 1.5 |
| Syn Fac DG | 0.9 |
| Fragrance | 0.6 |

“Formula 7”
(Solid Tablet)

| Ingredients | Amount (Percent by Weight) |
|---|---|
| Sodium percarbonate | 74.4 |
| EDTA | 5 |
| Granulated PEG 8000 | 20 |
| Fragrance | 0.6 |

| | |
|---|---|
| Ingredients | Amount (Percent by Weight) |

“Formula 8”
(Solid Tablet)

| | |
|---|---|
| Sodium percarbonate | 72 |
| EDTA | 5 |
| Flaked PEG 3350 | 20 |
| (polyethylene glycol having | |
| molecular weight of 3350) | |
| Formula A | 3 |

“Formula A”

| | |
|---|---|
| Antifoam Y 30 | 50 |
| Syn Fac DG | 30 |
| Fragrance | 20 |

“Formula 9”
(Solid Tablet)

| Ingredients | Amount (Percent by Weight) |
|---|---|
| Sodium percarbonate | 72 |
| EDTA | 5 |
| Granulated PEG 8000 | 20 |
| Formula A | 3 |

“Formula 10”
(Solid Tablet)

| Ingredients | Amount (Percent by Weight) |
|---|---|
| Sodium percarbonate | 74.4 |
| EDTA | 5 |
| Citric acid | 20 |
| Fragrance | 0.6 |

“Formula 11”
(Solid Tablet)

| Ingredients | Amount (Percent by Weight) |
|---|---|
| Sodium percarbonate | 70 |
| Boric acid | 30 |

“Formula 12”
(Solid Tablet)

| Ingredients | Amount (Percent by Weight) |
|---|---|
| Sodium percarbonate | 52 |
| EDTA | 4 |
| Granulated PEG 8000 | 4 |
| Citric acid | 10 |
| Boric acid | 29.5 |
| Polypropylene glycol 425 | 0.5 |
| (molecular weight = 425) | |

“Formula 13”
(Solid Tablet)

| Ingredients | Amount (Percent by Weight) |
|---|---|
| Sodium percarbonate | 52 |
| EDTA | 4 |
| Citric acid | 10 |
| Boric acid | 31.9 |
| Polypropylene glycol 425 | 1.5 |
| Fragrance | 0.6 |

“Formula 14”
(Solid Tablet)

| Ingredients | Amount (Percent by Weight) |
|---|---|
| Sodium percarbonate | 60 |
| EDTA | 3.83 |
| Sodium carbonate | 11.37 |
| Boric acid | 23.25 |
| Polypropylene glycol 425 | 1.03 |
| Fragrance | 0.52 |

“Formula 15”
(Solid Tablet)

| Ingredients | Amount (Percent by Weight) |
|---|---|
| Sodium percarbonate | 69.0 |
| EDTA | 4.4 |
| Sodium bicarbonate | 6.0 |
| Granulated PEG 8000 | 5.0 |
| Sorbitol | 15.0 |
| Fragrance | 0.6 |

### B. Comparative Example Description

Several commercially available cleaning compositions were also purchased for evaluation. These compositions are described as Comparative Examples 1-5 below.

### Comparataive Example 1

“Shout Oxy Power,” a powder cleaning product available from S.C. Johnson & Son, Inc.

### Comparative Example 2

“Clorox Regular Bleach,” a liquid cleaning product (containing 6% sodium hypochlorite) available from The Clorox Company.

### Comparative Example 3

“Ultra-Kleen™ CW502 Powder,” a powder cleaning product available from Sterilex Corporation.

### Comparative Example 4

“Washer Magic,” a liquid cleaning product available from Summit Brands.

### Comparative Example 5

“Purewasher,” a powder cleaning product available from “smellywasher.com” website.

### C. Test Methods and Evaluation

Test 1: Viability Validation of P. aeruginosa

Test 2: Biofilm/Microbial Growth Removal Test: Polypropylene Plaques

Test 3: Biofilm/Microbial Growth Removal Test: Inventive Granular Compositions vs. Comparative Cleaning Compositions

Test 4: Biofilm/Microbial Growth Removal Test: Inventive Granular Compositions vs. Comparative Cleaning Compositions—Effect of Temperature

Test 5: Biofilm/Microbial Growth Removal Test: Inventive Granular Cleaning Compositions—Effect of Antifoaming Agent

Test 6: Biofilm/Microbial Growth Removal Test: Inventive Granular Formulation vs. Inventive Solid Tablet—Effect of Citric Acid

Test 7: Biofilm/Microbial Growth Removal Test: Inventive Granular Formulation vs. Inventive Solid Tablet—Effect of Polyalkylene Glycol

Test 8: Biofilm/Microbial Growth Removal Test: Inventive Solid Tablet—Effect of Ethoxylated Alcohol

Test 9: Biofilm/Microbial Growth Removal Over Scale Test: Solid Inventive Tablet and Various Disk Substrates and Solid Cleaning Tablets

Test 1: Viability Validation of P. aeruqinosa

In order to develop a laboratory test that would simulate the wash and spin cycle of a standard washing machine, the following experiment was performed. Pseudomonas aeruginosa was selected due to its prevalence in water environments and its high predisposition for biofilm formation. Two samples of 10⁶ CFU/ml of P. aeruginosa were placed in sterile tap water in 30 mL plastic vials. The plastic vials were subjected to 3 cycles of 30 second sonication followed by 30 seconds vortexing. The number of viable cells in each vial was compared before (“Initial viability”) and after the sonication and vortexing cycles. The results are shown in Table 1 below.

TABLE 1
Viability of P. aeruginosa

| | | Viability after 3 cycles of |
|---|---|---|
| | | 30″ sonication + |
| Samples | Initial viability | 30″ vortexing |
| 1 | 4.28 × 10⁴ CFU/ml | 2.12 × 10⁴ CFU/ml |
| 2 | 4.28 × 10⁴ CFU/ml | 4.28 × 10⁴ CFU/ml |

Test results show that 3 cycles of sonication and vortexing do not affect the viability of P. aeruginosa in tap water.

### Test 2: Biofilm/Microbial Growth Removal Test:

### Polypropylene Plaques

In order to determine the biofilm/microbial growth removal efficiency of the chemical compositions of the present invention, polypropylene disks (1.5 cm in diameter; also referred to herein as “plaques”) were used to simulate polypropylene wash tubs. The plaques were inoculated with 10⁸ cells/ml of P. aeruginosa and allowed to grow a biofilm by incubating for eight weeks at ambient temperature and 180 rpm. After eight weeks, loosely adhered cells were removed from the plaques by lightly dipping the plaques in sterile water. The plaques were then placed in glass vials with 100 mM sodium/potassium phosphate buffer. The vials were then subjected to the following removal protocols:

A. Control (No Vortexing or Sonication, Just Rinse)

B. 3 cycles of 30 sec sonication followed by 30 sec vortexing.

The plaques were removed from the glass vials, and the number of cells recovered in the solution (i.e. removed from the plaques) was determined. The plaques were also stained with crystal violet to aid in determining removal efficacy. Staining of the plaque (i.e. positive result) indicates that the biofilm is still present on the plaque. No staining of the plaque (i.e. a negative result) indicates that the biofilm has been removed from the plaque. Test results are provided in Table 2 below.

TABLE 2
Biofilm Removal Efficacy of P. aeruginosa
From Polypropylene Plaques

| Removal Protocol | Crystal Violet Stain |
|---|---|
| A | Positive |
| B | Negative |

The results indicate that 3 cycles of sonication and vortexing appear to be sufficient to remove the eight week biofilm present on the polypropylene plaques.

### Test 3: Biofilm/Microbial Growth Removal Test:

Inventive Granular Compositions vs. Comparative Cleaning Compositions

Eight week old biofilms were grown on polypropylene disks (1.5 cm diameter) inoculated with a biofilm mixture recovered from a washing machine. The disks were treated with several inventive and comparative cleaning compositions to determine their ability to remove biofilm from the plaques and reduce odor. For sample preparation, 0.1 grams of each of Formulas 1 and 2 and Shout Oxy Power (“Comparative Example 1”) were independently added to 15 milliliters of water. Also, 0.53 ml of bleach was added to 15 ml liters of water (“Comparative Example 2”). The biofilms were treated with the cleaning composition for 15 minutes at 56° C. and 180 rpm. Crystal violet staining was used to determine whether the biofilm was removed from each plaque. Odor reduction was also evaluated. The results are provided in Table 3 below.

TABLE 3
Biofilm Removal Efficacy of
Inventive Granular Compositions versus
Comparative Cleaning Compositions

| Sample | Crystal Violet Stain | Odor Reduction |
|---|---|---|
| Tap Water | Positive | No odor reduction |
| Formula 1 | Negative | Good odor reduction |
| Formula 2 | Negative | Slight odor reduction |
| Comparative | Negative | Good odor reduction |
| Example 1 | | |
| Comparative | Positive | Strong chlorine odor |
| Example 2 | | |

### Test 4: Biofilm/Microbial Growth Removal Test:

Granular Inventive Compositions vs. Comparative Compositons—Effect of Temperature

Nine week old biofilms were grown on polypropylene disks (1.5 cm diameter) inoculated with a biofilm mixture recovered from a washing machine as described previously. The disks were treated with several inventive and comparative cleaning compositions to determine their ability to remove biofilm from the plaques and reduce odor. For sample preparation, 0.1 grams of each of Formulas 1 and 2 and Shout Oxy Clean (“Comparative Example 1”) and “Ultra-Kleen™ CW502” (“Comparative Example 3”) were independently added to 15 milliliters of water. Comparative Example 2 was prepared by adding 0.53 grams of bleach to 15 milliliters of water. A liquid cleaning composition, Washer Magic (“Comparative Example 4”), was also tested with 0.709 mL of the composition added to 15 milliliters of water.

The biofilms were treated with the cleaning composition for 15 minutes and 180 rpm at both 22° C. (i.e. room temperature) and at 56° C. Crystal violet staining was used to determine whether the biofilm was removed from each disk. Odor reduction was also evaluated.

After the treatment at 22° C., the odor reduction appeared to be good and fairly uniform among the samples. After the treatment at 56° C., the odor reduction was best for Comparative Example 1, followed by Comparative Example 3 and then Formula 1 and Formula 2. Again, Comparative Example 2 replaced the foul odor with a strong chlorine odor. Comparative Example 4 provided only a slight odor reduction.

With regard to biofilm removal, the samples were rated from best removal to least removal as follows:

Comparative Example 1 (56° C.)>Comparative Example 1 (22° C.)=Comparative Example 2 (56° C. and 22° C.)=Formula 1 (22° C. and 56° C.)>Formula 2 (22° C. and 56° C.)=Comparative Example 4 (56° C.)=Comparative Example 3 (56° C.)>Comparative Example 4 (22° C.)=Comparative Example 3 (22° C.).

### Test 5: Biofilm/Microbial Growth Removal Test:

### Inventive Granular Cleaning Compositions—Effect of Antifoaming Agent

Two week old biofilms were grown on polypropylene disks (1.5 cm in diameter) inoculated with biofilm mixture recovered from a washing machine as described previously. The disks were then treated with several inventive granular cleaning compositions to determine the effect of an antifoaming agent on their ability to remove biofilm from the plaques. For sample preparation, 0.1 grams of each of Formula 3 (no antifoaming agent) and Formula 4 (with antifoaming agent) were independently added to 15 milliliters of water.

The biofilms were treated with the cleaning composition for 15 minutes at 22° C. (i.e. room temperature) and 180 rpm. Crystal violet staining was used to determine whether the biofilm was removed from each plaque.

Both Formula 3 and Formula 4 removed biofilm from the plaques; however, Formula 4 performed better at removing the biofilm than Formula 3. Thus, the addition of an antifoaming agent to the formulations did not appear to have a detrimental effect on the biofilm removal capabilities of the formulations.

### Test 6: Biofilm/Microbial Growth Removal Test:

Inventive Granular Formulation vs. Inventive Solid Tablet—Effect of Citric Acid

Three week old biofilms were grown on polypropylene disks (1.5 cm in diameter) inoculated with biofilm mixture recovered from a washing machine as described previously. The disks were then treated with several inventive powder formulations and solid tablet formulations to determine their ability to remove biofilm from the plaques. For sample preparation, 0.1 gram of Formula 1 (granular) and Formula 5 (tablet form containing citric acid) were independently added to 15 milliliters of water.

The biofilms were treated with the cleaning composition for 15 minutes at 22° C. (i.e. room temperature) and 180 rpm. Crystal violet staining was used to determine whether the biofilm was removed from each plaque.

After the treatment at 22° C., both Formula 1 and Formula 5 effectively removed the biofilm. The addition of citric acid to the formulation did not appear to have a detrimental effect on the ability of the formulation to remove biofilm.

### Test 7: Biofilm/Microbial Growth Removal Test:

Inventive Granular Formulation vs. Inventive Solid Tablet—Effect of Polyalkylene Glycol

Two week old biofilms were grown on polypropylene disks (1.5 cm in diameter) inoculated with biofilm mixture recovered from a washing machine as described previously. The disks were then treated with several inventive and comparative cleaning compositions to determine their ability to remove biofilm from the plaques. Table 4 describes the samples that were prepared and tested.

TABLE 4
Granular and Solid Inventive Formulations
versus Comparative Cleaning Compositions

| Sample Description | Concentration in Water |
|---|---|
| Formula 4 | 0.4% |
| (granular form) | |
| Formula 5 | 0.4% |
| (solid tablet) | |
| Formula 6 | 0.4% |
| (solid tablet) | |
| Comparative Example 1 | 0.4% |
| (Shout Oxy Power) | |
| Comparative Example 5 | 0.4% |
| (Purewasher) | |
| Comparative Example 5 | 0.8% |
| (Purewasher) | |
| Tap water | control |

For test preparation, samples were added to a sufficient amount of water to create a solution containing either 0.4% or 0.8% of each cleaning composition.

The biofilms were treated with the cleaning composition for 15 minutes at 25° C. and 180 rpm. Crystal violet staining was used to determine whether the biofilm was removed from each plaque.

After the treatment at 22° C., all of the solid samples were able to remove the two week old biofilm, except for Comparative Example 5. This was achieved even for those samples which were present at 0.4% concentration. The performance at removing biofilm is ranked as follows from best removal to least removal: Formula 5>Formula 4=Formula 6>Comparative Example 1>tap water control>Comparative Example 5 (0.8%)>Comparative Example 5 (0.4%).

The incorporation of citric acid or polyethylene glycol did not appear to affect the biofilm removal efficacy of the solid cleaning compositions. The replacement of citric acid with polyethylene glycol did not appear to have a substantial effect on the performance of the solid cleaning tablet.

### Test 8: Biofilm/Microbial Growth Removal Test:

### Inventive Solid Tablet—Effect of Ethoxylated Alcohol

Two week old biofilms were grown on polypropylene disks (1.5 cm in diameter) inoculated with biofilm mixture recovered from a washing machine as described previously. The disks were then treated with several inventive solid tablet cleaning compositions to determine their ability to remove biofilm from the plaques. For sample preparation, Formula 6 and Formula 7 (0.4%; no antifoaming agent “Y-30” or ethoxylated alcohol “DG”) were independently added to 15 milliliters of water to obtain a final concentration of 0.4%.

The biofilms were treated with the cleaning composition for 15 minutes at 25° C. and 180 rpm. Crystal violet staining was used to determine whether the biofilm was removed from each plaque.

After the treatment at 25° C., both formulations effectively removed the biofilm from the plaques. The presence of the antifoaming agent or ethoxylated alcohol did not appear to have a detrimental effect on the efficacy of these formulations.

### Test 9: Biofilm/Microbial Growth Removal Over Scale Test:

### Solid Inventive Tablet and Various Disk Substrates

Scale formation was added to various disk substrates via incubation in the presence of sodium carbonate, calcium hydroxide, stearic acid, sodium hydroxide and calcium chloride.

Two week old biofilms were then grown on these disks (1.5 cm in diameter) inoculated with biofilm mixture recovered from a washing machine as described previously. The disk substrates include polypropylene, polystyrene, aluminum and stainless steel. The biofilms were then treated with Formula 5 solid tablet cleaning composition or with tap water (“Control”) to determine the ability of the cleaning composition to remove biofilm from the disks, as compared to that of tap water. For sample preparation, Formula 5 was added to a sufficient amount of water to yield a final concentration of Formula 5 in water of 0.2%.

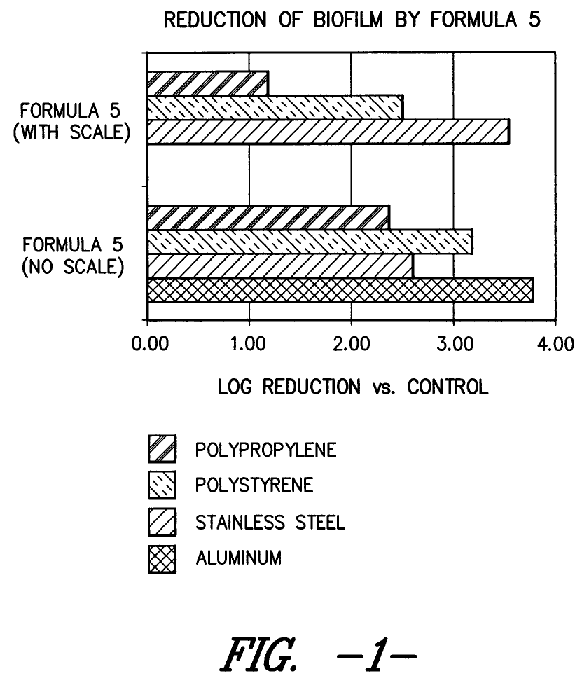

The biofilms were treated with the cleaning composition of Formula 5 for 15 minutes at 25° C. and 180 rpm. Loose cells were removed by rinsing the biofilm plaques in three cycles of 30 second sonication and 30 seconds of vortexing. Microbial counts were measured and compared with the control disks (disks treated only with tap water). Cells were dislodged in 10 mL of solution; thus, cells/disk is calculated by multiplying cells/mL by 10. Test results are graphically illustrated in FIG. 1.

FIG. 1 demonstrates that, unlike the Control samples, the Formula 5 solid cleaning tablet is effective at removing the biofilm from the disks (1-3 log reduction) on various disk substrates both with and without scale. However, the biofilm removal of polypropylene and aluminum appeared to be slightly better in the absence of scale. There was no difference between the Control sample and Formula 5 with scale for the aluminum substrate.

Thus, the above description and examples show that the inventive solid cleaning composition is efficacious at removing both scale and biofilm from various surfaces under worse case field scenarios with respect to the extent of biofilm buildup and the usage of low water temperature, and thus it is an effective product for both the prevention of biofilm formation and the renewal of appliances currently in use. As has been described herein, the solid cleaning composition possesses a significant advantage over current products, in that it does not have a deleterious effect on the appliance components, the clothing articles and tableware that may be washed therein, or the septic/sewer systems accepting waste from the cleaning process. Additionally, the composition has been designed to work with the machine cycle conditions (time, temperature, water volume, etc.) and to reduce or eliminate both the biological and the abiotic buildup.

These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the scope of the invention described in the appended claims.

We claim:

1. A solid cleaning composition comprising:
(a) a majority by weight of a cleaning active system, wherein the cleaning active system is comprised of a solid oxidizing agent and one or more compounds selected from the group consisting of a metal chelating agent and a carbonate-based compound; and
(b) one or more compounds selected from the group consisting of an acid component, wherein the acid component is present in an amount between 10% and 40% by weight of the total composition, and a polyalkylene glycol component.

2. The solid cleaning composition of claim 1, wherein the solid oxidizing agent is a percarbonate-based compound.

3. The solid cleaning composition of claim 2, wherein the solid oxidizing agent is present in an amount between 50% and 95% by weight of the total cleaning composition.

4. The solid cleaning composition of claim 2, wherein the percarbonate-based compound is sodium percarbonate.

5. The solid cleaning composition of claim 1, wherein the carbonate-based compound is selected from the group consisting of sodium carbonate, sodium bicarbonate and mixtures thereof.

6. The solid cleaning composition of claim 5, wherein the carbonate-based compound is present in an amount between 10% and 25% by weight of the total cleaning composition.

7. The solid cleaning composition of claim 1, wherein the metal chelating agent is selected from the group consisting of ethylene diamine tetracetic acid, tetraacetylethylenediamine and combinations thereof.

8. The solid cleaning composition of claim 1, wherein the acid component is selected from the group consisting of boric acid, citric acid, fumaric acid, lactic acid and combinations thereof.

9. The solid cleaning composition of claim 1, wherein the polyalkylene glycol component is selected from the group consisting of polypropylene glycol, polyethylene glycol, polybutylene glycol and combinations thereof.

10. The solid cleaning composition of claim 1, wherein the cleaning active system consists of a solid oxidizing agent and a metal chelating agent.

11. The solid cleaning composition of claim 10, wherein the cleaning active system consists of sodium percarbonate and ethylene diamine tetracetic acid.

12. The solid cleaning composition of claim 1, wherein the cleaning active system consists of a solid oxidizing agent, a metal chelating agent and a carbonate-based compound.

13. The solid cleaning composition of claim 12, wherein the cleaning active system consists of sodium percarbonate, ethylene diamine tetracetic acid and sodium carbonate.

14. The solid cleaning composition of claim 12, wherein the composition includes an acid component and a polyalkylene glycol component.

15. The solid cleaning composition of claim 1, wherein the composition further includes a fragrance.

16. The solid cleaning composition of claim 1, wherein the composition further includes one or more additives selected from the group consisting of antifoaming agents, surfactants, pesticides, coloring agents, antifungal agents, antimicrobial agents, effervescents, slow release agents, coating agents, and soil release agents.

17. The solid cleaning composition of claim 1, wherein the solid cleaning composition is in the form of a tablet.

18. The solid cleaning composition of claim 17, wherein the tablet is in the weight range of between 5 grams and 200 grams.

19. The solid cleaning composition of claim 17, wherein the tablet exhibits a rate of dissolution in the wash tub of a washing machine during a cleaning cycle characterized in that: (a) the tablet does not substantially dissolve during an initial rinse phase of the cleaning cycle and (b) the tablet dissolves during a subsequent phase of the cleaning cycle such that a substantial amount of the tablet does not remain in the wash tub at the end of the cleaning cycle.

20. A method for removing biofilm from a water contact surface comprising the sequential steps of:
(a) applying a sufficient amount of a solid cleaning composition to the water contact surface, wherein the solid cleaning composition comprises:
(i) a majority by weight of a cleaning active system, wherein the cleaning active system is comprised of a solid oxidizing agent and one or more compounds selected from the group consisting of a metal chelating agent and a carbonate-based compound; and
(ii) one or more compounds selected from the group consisting of an acid component, wherein the acid component is present in an amount between 10% and 40% by weight of the total composition, and a polyalkylene glycol component;
(b) adding a sufficient amount of water to the water contact surface to allow the solid cleaning composition to dissolve and form a mixture of water and cleaning composition;
(c) agitating the mixture of step “b”;
(d) removing the mixture of step “c” from the water contact surface; and
(e) rinsing the water contact surface.

21. The method of claim 20, wherein the water contact surface is the interior of a washing machine.

22. The method of claim 20, wherein step “a” of applying is accomplished by adding the solid cleaning composition to the wash tub of the washing machine.
